(19) United States
(12) Patent Application Publication
(10) Pub. No.: US 2007/0265893 A1
(43) Pub. Date: Nov. 15, 2007

(54) A method of determining the effectiveness of an internet web site

(76) Inventor: Scott L. Nielson, (US)

Correspondence Address: SCOTT NIELSON, 1076 WALBURK AVE, LAYTON, UT, 84040, US

(21) Appl. No.: 11/382,399

(22) Filed: May 9, 2006

(51) Int. Cl. G06F 17/50

(52) U.S. Cl. 705/7

(57) ABSTRACT

A method of determining the effectiveness of an internet web site is described. The method provides a means for web site owners to review a comprehensive set of variables in a value chain comprising data sets, were each variable is analyzed and weighted reflecting the overall goal of the evaluation criterion. The end result produces a number on a scale, generally between one and one hundred and the web site owner can then use the evaluation results to predict changes that are required to make improvements on the web site.

### THE FIELD OF THE INVENTION

The present invention relates to a method of determining the effectiveness of a web site by establishing an evaluation criterion with a goal, gathering and analyzing data sets that are necessary to deliver the objectives of the criterion and then producing a value to reflect the overall effectiveness of the web site and predict how the web site owner may effect changes to make improvements towards the desired objectives.

### BACKGROUND AND RELATED ART

This invention relates generally to web site analysis by considering web site design, internet traffic analysis, internet search behaviors, and more particularly to a method for analyzing comprehensive factors that make up the internet in determining the overall effectiveness of a web site.

The worldwide web (hereinafter “web”) has demonstrated itself as one of the most important publishing and interactive mediums. Web servers are interconnected via the Internet, which provides instant access to a global audience. Web sites are relatively simple to create requiring minor technical skills. Because of the relative ease of creating a web site, the number of web sites on the internet has proliferated. The data available on the web has been assembled by private individuals, commercial companies, government agencies, and special interest organizations. Much of this information is organized into web pages. A web site is a collection of web pages or files offered by a sponsoring entity (herein “site owner”).

Large web sites are typically organized hierarchically. For example, corporate web sites often consist of smaller web sites, each providing information about a business unit of the parent company. Unlike other forms of media, a web site is interactive and the web server can passively gather access information about each user by observing and logging the traffic data packets exchanged between the web server and the user.

A visit to a web site is defined as a series of downloads, from a specified web server by a fixed client browser, that are contiguous in time. Each request for a web file made by a client browser during the course of a visit is referred to as a hit. Important facts about the user can be determined directly or inferentially by analyzing the user hits. Data collected over a period of time can yield statistical information, such as the number of users visiting the site each day, what countries, states or cities the users connect from, and the most active day or hour of the week.

The current field is rampant with various solutions to analyze web site traffic (the hits noted above). Analyzing web site traffic data for even a single day to identify trends or generate statistics is computationally intensive and time-consuming. Because of this many inventions fail to consider vital and important factors when providing reports about the effectiveness of a web site to the site owner on a larger scale then just traffic analysis.

The problem with the current field of invention is that too much emphasis has been placed upon analyzing just traffic rather then analyzing the web site as a whole. Traffic analysis can tell a site owner a great deal about how busy their web is and where users spend most of their time when they arrive at their web site. However, traffic analysis can do little to tell a business owner how to make improvements to their web site as it relates to the internet in the aggregate; at best the current field of invention can speculate about web pages that are performing better then other pages and attempt to draw inferences from that single web page.

There is a need to analyze more than web site traffic and focus on internet behaviors (traffic, web site characteristics, design, and relevant search parameters) as an all inclusive or global analysis to better facilitate decisions about the web site and the business behaviors relating to internet interactivity, marketing and future development.

### BRIEF DESCRIPTION OF THE DRAWINGS

In order to describe the manner in which the recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered as limiting its scope, the invention will be described and explained with additional specificity and detail through the use of the accompanying drawings in which:

FIG. 1 is a flowchart demonstrating the method of taking data results and analyzing them through the evaluation criteria to arrive at a final weighted score.

### DETAILED DESCRIPTION OF THE PREFERRED EMBODIMENTS

The present invention is directed to a method involving an evaluation of the effectiveness of a website on the internet. The method provides a means for web site owners to review a comprehensive set of variables in a value chain comprising data sets, were each variable is analyzed and weighted reflecting the overall goal of the evaluation criterion. The end result produces a number on a scale, generally between one and one hundred and the web site owner can then use the evaluation results to predict changes that are required to make improvements on the web site to accomplish the site owner's objectives. It should be clear, however, that in practicing the invention, many tasks may be performed in an arbitrary order, and therefore any particular order implied by the description usually represents one of many possibilities.

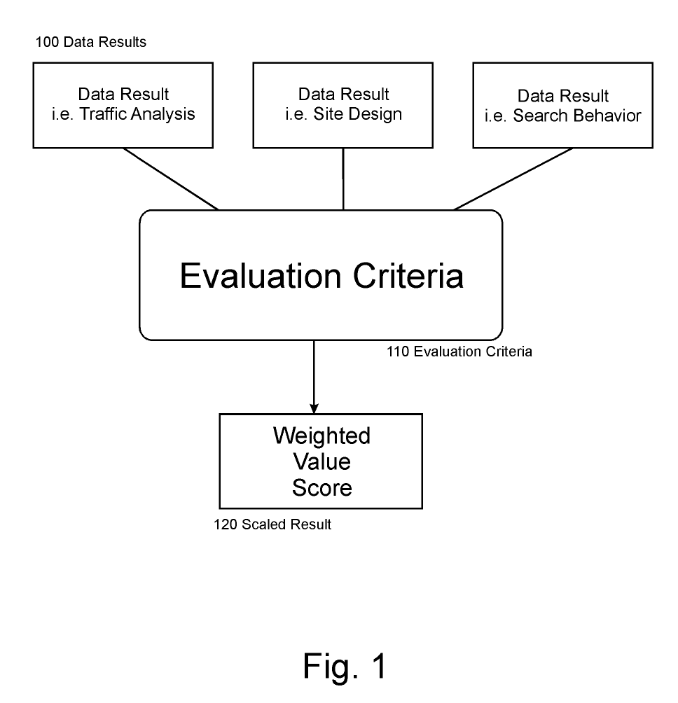

The flowchart of FIG. 1 outlines the basic steps required to accomplish the method of evaluating the effectiveness of a web site as it relates to the Internet as a whole. The web site owner starts by establishing an evaluation criterion (110) that reflects the web site owner's objectives. After the evaluation criteria is determined, then the required data sets (100) are ascertained and then evaluated by incorporating the evaluation criteria and reviewing the data sets for the relevant factors that may reflect positively or negatively on the desired outcome of the web site owners objective. After the analysis step has concluded, each data set result is then weighted in relationship to all data set results and then summed to arrive at a final weighted score (120) that can be used by the web site owner to make decisions regarding their web site and the requirements for making improvements to their web site as a whole in relationship to the Internet at large.

The first step in the method includes establishing an evaluation criterion with a specific goal for the website owner. This is generally a goal of determining the overall effectiveness of the web site as it relates to various data sets reflecting statistical data of traffic analysis, web site design considerations, and search engine behaviors (100).

The next step involves the method of determining which data sets should be used in pursuit of the overall objective. While the data set choices can be vast, generally the data sets will include statistical data relating to web site traffic, search engine behaviors, site design, server infrastructure and web site security.

After the proper data sets and evaluation criteria have been determined, each data set is then evaluated and analyzed against the evaluation criteria. The objective of this step is to identify relevant factors in the data sets as they relate to the evaluation criteria. The results of this evaluation of each data set are stored to be used later throughout the invention. All of the data results utilized comprise a total raw score that can be considered in accomplishing the overall objective; however the current invention contemplates refinement of this raw score.

Once every data set has been evaluated and a data set result score assigned, then the next step of determining the weight value to give each data set result score is achieved. This is done by comparing all of the data sets and assigning weighted values for each data set as it relates to the overall evaluation criteria and goal to be achieved. Finally the weighted value is then attributed to the data set result.

The final step in the method involves the summing of all weighted data set results to arrive at an all inclusive number reflecting a range of values. For example, the range of values for the evaluation criteria might be between one and a hundred and the summation of all data results (when properly weighted) may result in a final number of sixty-seven. This type of scoring, along with the feedback as to the weighting and values of each independent data set is designed to aid the web site owner in making improvements to their web site for the Internet as a whole.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of determining the effectiveness of an internet web site comprising the steps of:
establishing an evaluation criterion with a specific goal; determining the data sets that must be used; analyzing each data set against the criterion; assigning a weighted value for the result of each data set; producing a scaled number based upon the results by combining all data sets results analyzed.

2. The method of claim 1, wherein the establishing an evaluation criterion means the determination of an overall objective to be achieved by the analysis of data sets.

3. The overall objective of claim 2, wherein the overall objective may include general goals of improving a web sites performance, overall internet presence, functionality and design.

4. The method of claim 1, wherein the establishing an evaluation criterion may comprise using a template with previously identified goals to be achieved, which already has the necessary data sets identified for analysis.

5. The method of claim 1, wherein the specific goal may reflect any business objective as it relates to a web site or the desire of the web site owner to make improvements to the web site is it relates to measurable characteristics.

6. The method of claim 1, wherein the step of determining the data sets that must be used includes the method of reviewing the type of data that would be helpful in rendering relevant values as the data may effect the overall objectives of the evaluation criterion. This includes data that may positively or negatively affect the outcome of the desired result. This step produces an array of data sets that will be evaluated by the evaluation criterion.

7. The method of claim 1, wherein analyzing each data set against the criterion includes a detailed review of the data with specific factors being recorded, assessed and tabulated as the data intersects the specific factors comprising the evaluation criterion. This step produces a data set result.

8. The method of claim 1, wherein assigning a weighted value for the result of each data set includes the creation of a value in relationship to all other data set results, which were analyzed for the overall evaluation and objective criterion. This relationship value is accomplished for each unique data set result.

9. The method of claim 1, wherein producing a scaled number by combining all of the data set results analyzed includes the step of summing the different weighted value of each data set result analyzed and producing a final value as it relates to the evaluation criterion as a whole.
